(19) United States
(12) Patent Application Publication
(10) Pub. No.: US 2023/0214692 A1
(43) Pub. Date: Jul. 6, 2023

(54) INFORMATION PROCESSING APPARATUS, INFORMATION PROCESSING METHOD, AND COMPUTER-READABLE RECORDING MEDIUM

(71) Applicant: NEC Corporation, Minato-ku, Tokyo (JP)

(72) Inventor: Kazeto YAMAMOTO, Tokyo (JP)

(73) Assignee: NEC Corporation, Minato-ku, Tokyo (JP)

(21) Appl. No.: 17/928,550

(22) PCT Filed: Jun. 1, 2020
(86) PCT No.: PCT/JP2020/021546

§ 371 Date: Nov. 29, 2022

(51) Int. Cl. G06N 5/04

(52) U.S. Cl. CPC G06N 5/041

(57) ABSTRACT

An information processing apparatus comprises the constraint enumeration unit that enumerates, for a plurality of candidate hypotheses generated from a query formula and background knowledge, constraints to be satisfied by the candidate hypotheses, the redundant constraint deletion unit that searches for and deletes redundant constraints not to affect an inference result from the constraints enumerated by the constraint enumeration means, and the candidate hypothesis conversion unit generates a combinatorial optimization problem from the plurality of candidate hypotheses and a set of constraints enumerated by the constraint enumeration unit that remain after the deletion of redundant constraints by the redundant constraint deletion unit.

### TECHNICAL FIELD

The present invention relates to an inference processing method in a system based on abduction, and to an information processing apparatus, an information processing method and a computer-readable recording medium that exclude redundant constraints from computation, among constraints to be satisfied by individual hypothesis candidates.

### BACKGROUND ART

Abduction (abductive reasoning) is an inference method that involves receiving a query formula and background knowledge, and outputting a hypothesis (solution hypothesis) that is non-contradictory with the background knowledge and is a best hypothesis among logic formulas (hypotheses) that can deductively derive the query formula, on the basis of a function (evaluation function) expressing the merits of individual candidates with actual values.

A method for obtaining a best hypothesis using an external solver by enumerating best hypothesis candidates (candidate hypotheses) from a query formula and background knowledge, and equivalently converting the problem of searching for a best hypothesis therefrom as a constrained combinatorial optimization problem such as an integer linear programming problem, such as shown in Non-Patent Document 1, is given as an example of an existing method for implementing abduction on a computing device.

More specifically, in this existing method, a set of candidate hypotheses that are enumerated from a query formula and background knowledge is expressed by a graph (latent hypothesis graph) obtained by representing the derived relation between logic formulas by a directed graph for unions of the logic formula sets constituting the candidate hypotheses. At this time, each candidate hypothesis corresponds to one of subgraphs of the latent hypothesis graph, and the problem of searching for a solution hypothesis is reduced to the problem of searching for a best subgraph in the latent hypothesis graph. Also, the logic constraints to be satisfied by each candidate hypothesis in order to be non-contradictory with the background knowledge are represented as constraints in a constrained combinatorial optimization problem.

### LIST OF RELATED ART DOCUMENTS

### Non-Patent Document

Non-Patent Document 1: Naoya Inoue and Kentaro Inui, ILP-based Reasoning for Weighted Abduction, in Proceedings of AAAI Workshop on Plan, Activity and Intent Recognition, pp. 25-32, August 2011.

### SUMMARY OF INVENTION

### Problems to be Solved by the Invention

In implementation based on the conventional method, there is a problem in that the computation speed decreases markedly as the number of logic constraints to be considered increases. In the conventional method, as described above, inappropriate hypotheses are excluded from being candidates by representing the logic constraints to be satisfied by each candidate hypothesis as constraints in a constrained combinatorial optimization problem. That is, a problem with the conventional method is that while the scale of the constrained combinatorial optimization problem to be solved increases as the number of logic constraints to be considered increases, whether or not each logic constraint needs to be considered cannot be judged until the optimization problem is given to the external solver. The constrained combinatorial optimization problem thereby becomes increasingly redundant as the number of the redundant constraints in the set of logic constraints increases, and, as a result, the inference computation time is extended.

An example object of the invention is to provide an information processing apparatus, an information processing method and a computer-readable recording medium that are able to improve the computational efficiency of inference as a whole.

### Means for Solving the Problems

In order to achieve the aforementioned object, an information processing apparatus according to an example aspect of the present invention comprising: a constraint enumeration unit that enumerates, for a plurality of candidate hypotheses generated from a query formula and background knowledge, constraints to be satisfied by the candidate hypotheses; a redundant constraint deletion unit that searches for and deleting redundant constraints not to affect an inference result from the constraints enumerated by the constraint enumeration unit; and a candidate hypothesis conversion unit that generates a combinatorial optimization problem from the plurality of candidate hypotheses and a set of constraints enumerated by the constraint enumeration unit that remain after the deletion of redundant constraints by the redundant constraint deletion unit.

In order to achieve the aforementioned object, an information processing method according to an example aspect of the present invention comprising: enumerating, for a plurality of candidate hypotheses generated from a query formula and background knowledge, constraints to be satisfied by the candidate hypotheses; searching for and deleting redundant constraints not to affect an inference result from the enumerated constraints; and generating a combinatorial optimization problem from the plurality of candidate hypotheses and a set of enumerated constraints that remain after the deletion of redundant constraints.

In order to achieve the aforementioned object, a computer-readable recording medium according to an example aspect of the present invention, that includes a program recorded thereon, the program including instructions that cause a computer to carry out: enumerating, for a plurality of candidate hypotheses generated from a query formula and background knowledge, constraints to be satisfied by the candidate hypotheses; searching for and deleting redundant constraints not to affect an inference result from the enumerated constraints; and generating a combinatorial optimization problem from the plurality of candidate hypotheses and a set of enumerated constraints that remain after the deletion of redundant constraints.

### Advantageous Effects of the Invention

According to the present invention, the computational efficiency of inference as a whole can be improved.

### BRIEF DESCRIPTION OF THE DRAWINGS

FIG. 1 is a configuration diagram illustrating a schematic configuration of an information processing apparatus in the example embodiment.

FIG. 2 is a configuration diagram illustrating a specific configuration of the information processing apparatus in the example embodiment.

FIG. 3 is a flow diagram illustrating operations of the information processing apparatus in the example embodiment.

FIG. 4 is a diagram illustrating an example of the query formula and the background knowledge.

FIG. 5 is a diagram illustrating the candidate hypothesis set that is generated from the query formula and the background knowledge illustrated in FIG. 4.

FIG. 6 is a diagram illustrating an example of conjunctions leading to contradictions that are created by the conventional method in the candidate hypothesis set of FIG. 5.

FIG. 7 is a block diagram showing one example of a computer that realizes the information processing apparatus in the example embodiment.

### EXAMPLE EMBODIMENTS

### [Apparatus Configuration]

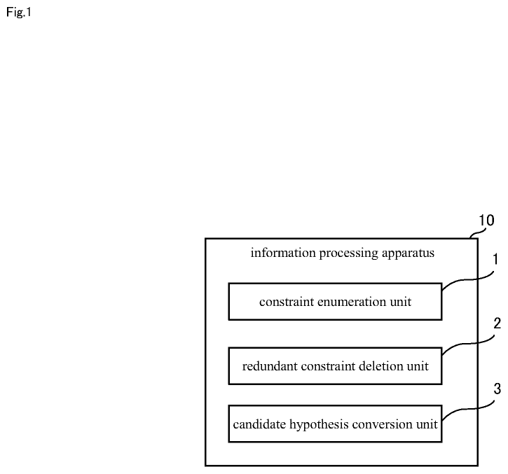

FIG. 1 is a configuration diagram illustrating a schematic configuration of an information processing apparatus 10 in the example embodiment.

The information processing apparatus 10 includes a constraint enumeration unit 1, a redundant constraint deletion unit 2 and a candidate hypothesis conversion unit 3.

The constraint enumeration unit 1 enumerates, for a plurality of candidate hypotheses that are generated from a query formula and background knowledge, constraints to be satisfied by the candidate hypotheses.

The redundant constraint deletion unit 2 searches for and deletes redundant constraints that will not affect the inference result from the constraints enumerated by the constraint enumeration unit 1.

The candidate hypothesis conversion unit 3 generates a combinatorial optimization problem from the plurality of candidate hypotheses and a set of constraints enumerated by the constraint enumeration unit 1 that remain after the deletion of redundant constraints by the redundant constraint deletion unit 2.

According to this information processing apparatus 10, the computational efficiency of inference as a whole can be improved, by redundant constraints, among the logic constraints to be considered in the candidate hypotheses, that will not affect the inference result even if not considered being excluded from computation, at a point in time before the optimization problem is given to the external solver.

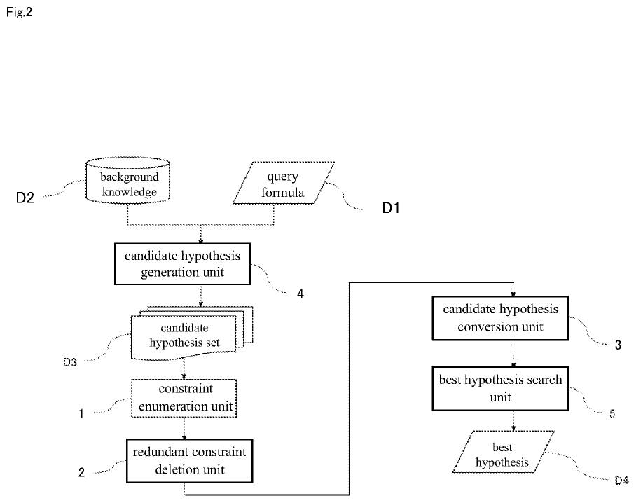

Next, the configuration and functions of the information processing apparatus in the example embodiment will be specifically described, using FIGS. 2 to 6.

FIG. 2 is a configuration diagram illustrating a specific configuration of the information processing apparatus 10 in the example embodiment.

The information processing apparatus 10 includes a candidate hypothesis generation unit 4 and a best hypothesis search unit 5, in addition to the constraint enumeration unit 1, the redundant constraint deletion unit 2 and the candidate hypothesis conversion unit 3 described above.

The candidate hypothesis generation unit 4 receives a query formula D1 and background knowledge D2 as inputs, generates a candidate hypothesis set D3, which is a set of candidate hypotheses, from the query formula D1 and the background knowledge D2, and outputs the candidate hypothesis set D3.

The query formula D1 is a conjunction of first-order predicate logic literals. A first-order predicate logic literal is an atomic formula in a first-order predicate logic or the negation thereof.

The background knowledge D2 is a set of inference rules. An inference rule is generally expressed with a Horn clause in a first-order predicate logic. More specifically, with a latent hypothesis graph corresponding to a candidate hypothesis consisting only of the query formula D1 as an initial state, an operation for expanding the latent hypothesis graph, that is, an operation for generating a new candidate hypothesis, is repeated until a new operation can no longer be performed. The operation that is used at this time is basically the operation employed in the conventional method, but it is also possible to use other methods.

The candidate hypothesis set D3 is a set of candidate hypotheses, and is basically represented in the form of a latent hypothesis graph. The candidate hypotheses are each represented as a conjunction of first-order predicate logic literals. The latent hypothesis graph is represented as a directed graph with the first-order predicate logic literals of each candidate hypothesis as nodes.

If based on Non-Patent Document 1, the candidate hypothesis generation unit 4 generates a new candidate hypothesis by selecting and applying one applicable operation, with the candidate hypothesis consisting only of the query formula D1 as the initial state. Applicable operations include backward chaining and unification.

Backward chaining is an operation that involves applying a rule included in the background knowledge D2 backwardly to an existing candidate hypothesis. In backward chaining, a hypothesis obtained by corresponding a literal in the candidate hypothesis to the consequent (right side, consequence) of the rule and adding a literal corresponding to the antecedent (left side, premise) thereto is generated as a new candidate hypothesis.

Unification is an operation that involves generating, as a new candidate hypothesis, a hypothesis obtained by adding, to a pair of literals having the same predicate in existing candidate hypotheses, an equivalence relation between arguments such that the pair of literals are identical.

The constraint enumeration unit 1 enumerates the constraints to be satisfied by the respective candidate hypotheses included in the candidate hypothesis set D3. More specifically, the constraint enumeration unit 1 enumerates the logic constraints to be satisfied by the candidate hypotheses, by searching, for each literal in the literal set included in the latent hypothesis graph and each rule included in the background knowledge, for combinations of literals that contradict the rule.

The redundant constraint deletion unit 2 determines whether there are any redundant constraints that need not be considered, among the constraints enumerated by the constraint enumeration unit 1, and, if there are any redundant constraints, excludes those redundant constraints from computation. More specifically, having enumerated which combination of nodes on the latent hypothesis graph satisfy each constraint, the redundant constraint deletion unit 2 determines, based on the graph structure of the latent hypothesis graph, whether a combination of nodes corresponding to a certain constraint always holds when combinations of nodes corresponding to other constraints hold. Note that the method of determination is not limited thereto.

The candidate hypothesis conversion unit 3 generates a combinatorial optimization problem that is equivalent to a procedure for selecting a best candidate hypothesis that satisfies all constraints from the candidate hypothesis set D3 and the set of constraints. If based on Non-Patent Document 1, the combinatorial optimization problem that is generated is expressed as an integer linear programming problem. Variables in the combinatorial optimization problem correspond to the presence of literals in the candidate hypotheses, and constraints in the optimization problem are used in order to express logic constraints in the candidate hypotheses, preconditions resulting from the evaluation function, and the like. Also, the objective function in the optimization problem is designed to be equivalent to the evaluation function in abduction. Note that the candidate hypothesis conversion unit 3 basically generates the combinatorial optimization problem using the conventional method, but the method is not particularly limited thereto.

The best hypothesis search unit 5 receives the combinatorial optimization problem generated by the candidate hypothesis conversion unit 3 as an input, searches for an optimal solution to the optimization problem using an external solver, and outputs a best hypothesis D4 obtained therefrom.

The best hypothesis D4 satisfies constraints to be satisfied among the candidate hypotheses included in the candidate hypothesis set D3, and is the best hypothesis on the basis of the evaluation function.

The best hypothesis search unit 5 searches for a best hypothesis from the candidate hypothesis set D3 and outputs the best hypothesis. This processing is realized by using an external solver that depends on the type of combinatorial optimization problem that is generated by the candidate hypothesis conversion unit 3. If based on Non-Patent Document 1, an optimal solution is obtained using a solver for integer linear programming problems, and the candidate hypothesis corresponding to that optimal solution is output as the best hypothesis.

### [Apparatus Operations]

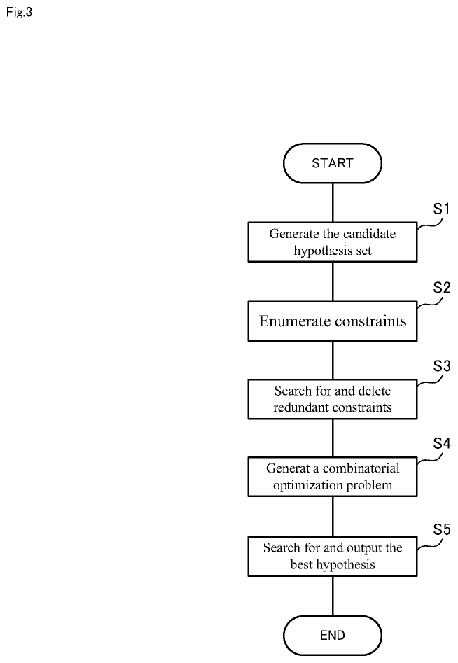

Next, operations of the information processing apparatus 10 in the example embodiment will be described using FIGS. 3 to 6. FIG. 3 is a flow diagram illustrating operations of the information processing apparatus 10 in the example embodiment. In the following description, FIGS. 1 and 2 will be referred to as appropriate. Also, in the example embodiment, an information processing method is implemented by operating the information processing apparatus. Therefore, the following description of operations of the information processing apparatus is given in place of description of the information processing method in the example embodiment.

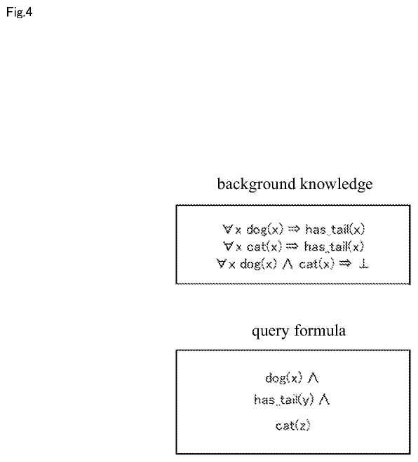

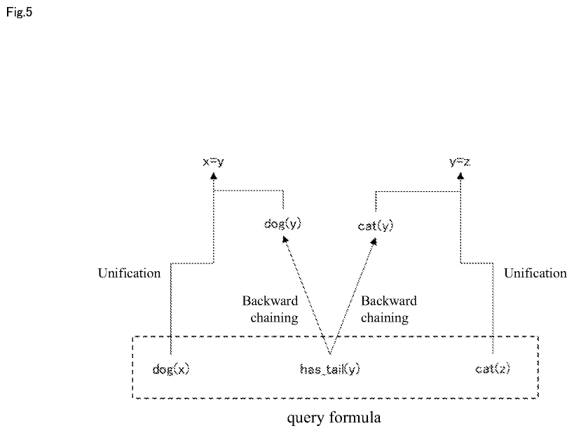

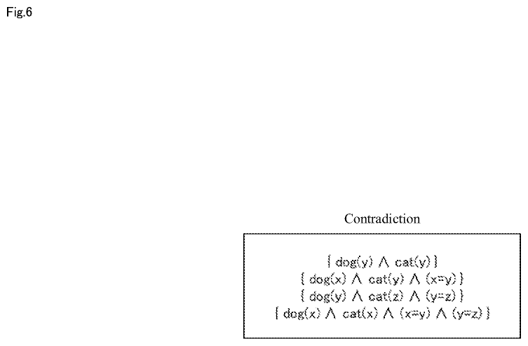

FIG. 4 is a diagram illustrating an example of the query formula D1 and the background knowledge D2. FIG. 5 is a diagram illustrating the candidate hypothesis set D3 that is generated from the query formula D1 and the background knowledge D2 illustrated in FIG. 4. FIG. 6 is a diagram illustrating an example of conjunctions leading to contradictions that are created by the conventional method in the candidate hypothesis set D3 of FIG. 5.

The candidate hypothesis generation unit 4 generates the candidate hypothesis set D3 from the query formula D1 and the background knowledge D2 (S1). The candidate hypothesis generation unit 4 constructs the candidate hypothesis set D3, by applying a backward chaining operation and a unification operation, with a latent hypothesis graph corresponding to the candidate hypothesis set D3 including only the candidate hypothesis consisting only of the query formula D1, that is, {dox(x)∧has_tail(y)∧cat(z)}, as the initial state. In the example in FIG. 4, literals dog(y) and cat(y) are added to the latent hypothesis graph, by applying the backward chaining operation to the literal has_tail(y) for the rules ∀×dog(x)⇒has_tail(x) and ∀×cat(x)⇒has_tail(x), respectively. The candidate hypothesis generation unit 4 then adds (x=y) and (y=z) to the latent hypothesis graph, by applying the unification operation to dog(x) and dog(y) and to cat(y) and cat(z), respectively. Finally, the candidate hypothesis generation unit 4 generates the candidate hypothesis set D3 represented by a latent hypothesis graph such as illustrated in FIG. 5.

The constraint enumeration unit 1 enumerates, for the respective candidate hypotheses included in the candidate hypothesis set D3, constraints to be satisfied by the candidate hypotheses (S2). More specifically, the constraint enumeration unit 1 enumerates conjunctions that lead to contradictions, among the conjunctions that are constituted by the literals included in the latent hypothesis graph. In the example in FIG. 6, the constraint enumeration unit 1 enumerates combinations of literals corresponding to the rules such as ∀×dog(x)∧cat(x)⇒⊥ to thus obtain a set of conjunctions such as illustrated in FIG. 6.

Having computed which node group on the latent hypothesis graph satisfies each constraint, the redundant constraint deletion unit 2 searches the node groups corresponding to the individual constraints for constraint pairs in which one constraint always holds when the other constraints in the pairs hold, and deletes the latter (S3). In the example in FIG. 6, dog(y) A cat(y) always holds in a situation where each of the lower three constraints hold. Accordingly, the redundant constraint deletion unit 2 determines that the lower three constraints are redundant constraints that do not need to be considered and deletes these constraints. As a result, only dog(y) A cat(y) is output as the final set of constraints.

Note that, with the conventional method, such redundant constraints cannot be recognized, and thus are all enumerated as constraints to be kept and represented in the combinatorial optimization problem, even though most of the constraints illustrated in FIG. 6 are redundant, resulting in excess computational load being incurred.

The candidate hypothesis conversion unit 3 generates a combinatorial optimization problem (S4). Specifically, the candidate hypothesis conversion unit 3 represents and outputs, as a combinatorial optimization problem, a procedure for searching for the best hypothesis, among the candidate hypotheses that are included in the candidate hypothesis set D3 and do not satisfy the combinations included in the latent contradiction set. In Non-Patent Document 1, the procedure for searching for the best hypothesis is represented as an equivalent integer linear programming problem.

The best hypothesis search unit 5 receives the combinatorial optimization problem as an input from the candidate hypothesis conversion unit 3, and searches for and outputs the best hypothesis (S5). In Non-Patent Document 1, the search for the best hypothesis is performed by receiving an integer linear programming problem as an input and solving this problem using an external solver for integer linear programming problems.

As described above, according to the information processing apparatus 10 of the example embodiment, redundant constraints that will not affect the solution can be excluded from conversion to (generation of) the combinatorial optimization problem. Also, by being able to exclude redundant constraints from conversion to the combinatorial optimization problem, the numbers of variables and constraints constituting the combinatorial problem can be reduced accordingly, and thus the same inference as the conventional method can be represented as a smaller combinatorial optimization problem than with the conventional method. Furthermore, memory and computation time in the procedure for searching for the optimal solution by the external solver are reduced, by reducing the size of the combinatorial optimization problem given to the external solver, and thus the procedure for abduction as a whole can be performed more efficiently than with the conventional method in terms of both memory and computation time.

### [Program]

A program in the example embodiment need only be a program that causes a computer to execute steps S1 to S5 illustrated in FIG. 3. The information processing apparatus 10 and the information processing method in the example embodiment can be realized, by installing and executing this program on a computer. In this case, a processor of the computer functions and performs processing as the constraint enumeration unit 1, the redundant constraint deletion unit 2, the candidate hypothesis conversion unit 3, the candidate hypothesis generation unit 4 and the best hypothesis search unit 5.

Also, examples of the computer include a smartphone and a tablet-type terminal device, in addition to a general-purpose PC.

Also, the program in the example embodiment may be executed by a computer system constructed from a plurality of computers. In this case, for example, the computers may respectively function as one of the constraint enumeration unit 1, the redundant constraint deletion unit 2, the candidate hypothesis conversion unit 3, the candidate hypothesis generation unit 4 and the best hypothesis search unit 5.

[Physical Configuration]

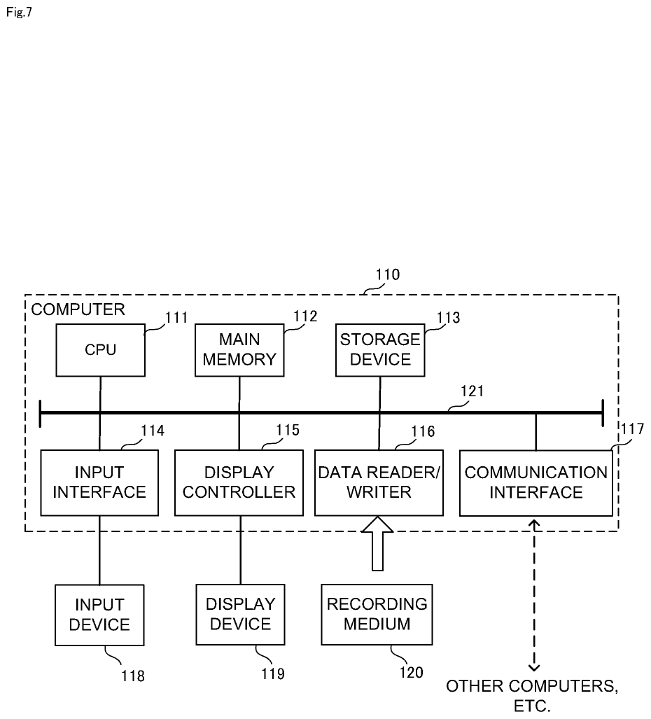

Hereinafter, a computer that realizes the information processing apparatus 10 by executing the program in the example embodiment will be described with reference to FIG. 7. FIG. 7 is a block diagram showing one example of a computer that realizes the information processing apparatus 10 in the example embodiment.

As shown in FIG. 7, a computer 110 includes a CPU 111, a main memory 112, a storage device 113, an input interface 114, a display controller 115, a data reader/writer 116, and a communication interface 117. These components are connected in such a manner that they can perform data communication with one another via a bus 125.

Note that the computer 110 may include a GPU (Graphics Processing Unit) or an FPGA (Field-Programmable Gate Array) in addition to the CPU 111 or in place of the CPU 111.

The CPU 111 carries out various types of computation by deploying the program (codes) in the present example embodiment stored in the storage device 113 to the main memory 112, and executing the deployed program in a predetermined order. The main memory 112 is typically a volatile storage device, such as a DRAM (Dynamic Random Access Memory).

Also, the program in the present example embodiment is provided in a state where it is stored in a computer readable recording medium 120. Note that the program in the present example embodiment may also be distributed over the Internet connected via the communication interface 117.

Furthermore, specific examples of the storage device 113 include a hard disk drive, and also a semiconductor storage device, such as a flash memory. The input interface 114 mediates data transmission between the CPU 111 and an input apparatus 118, such as a keyboard and a mouse. The display controller 115 is connected to a display apparatus 119, and controls displays on the display apparatus 119.

The data reader/writer 116 mediates data transmission between the CPU 111 and the recording medium 120, and executes readout of the program from the recording medium 120, as well as writing of the result of processing in the computer 110 to the recording medium 120. The communication interface 117 mediates data transmission between the CPU 111 and other computers.

Also, specific examples of the recording medium 120 include: a general-purpose semiconductor storage device, such as CF (Compact Flash®) and SD (Secure Digital); a magnetic recording medium, such as Flexible Disk; and an optical recording medium, such as CD-ROM (Compact Disk Read Only Memory).

Note that the information processing apparatus 10 in the present example embodiment can also be realized using items of hardware corresponding to respective components, rather than using the computer with the program installed therein. Furthermore, a part of the information processing apparatus 10 may be realized by the program, and the remaining part of the information processing apparatus 10 may be realized by hardware.

A part or all of the aforementioned example embodiment can be described as, but is not limited to, the following (Supplementary Note 1) to (Supplementary Note 6).

(Supplementary Note 1)

An information processing apparatus comprising:

a constraint enumeration unit that enumerates, for a plurality of candidate hypotheses generated from a query formula and background knowledge, constraints to be satisfied by the candidate hypotheses;

a redundant constraint deletion unit that searches for and deleting redundant constraints not to affect an inference result from the constraints enumerated by the constraint enumeration unit; and

a candidate hypothesis conversion unit that generates a combinatorial optimization problem from the plurality of candidate hypotheses and a set of constraints enumerated by the constraint enumeration unit that remain after the deletion of redundant constraints by the redundant constraint deletion unit.

(Supplementary Note 2)

The information processing apparatus according to Supplementary Note 1,

wherein the plurality of candidate hypotheses are represented in a form of a latent hypothesis graph represented as a directed graph with literals as nodes, and

the redundant constraint deletion unit searches for redundant constraints, based on a graph structure of the latent hypothesis graph.

(Supplementary Note 3)

The information processing apparatus according to Supplementary Note 1 or 2, comprising:

a candidate hypothesis generation unit that generates a candidate hypothesis set which is a set of candidate hypotheses, from the query formula and the background knowledge,

wherein the constraint enumeration unit enumerates constraints for the respective candidate hypotheses included in the candidate hypothesis set generated by the candidate hypothesis generation unit.

(Supplementary Note 4)

The information processing apparatus according to any one of Supplementary Note 1 to 3, comprising:

a best hypothesis search unit that searches for a best hypothesis using an external solver, based on the optimization problem generated by the candidate hypothesis conversion unit.

(Supplementary Note 5)

An information processing method comprising:

a step of enumerating, for a plurality of candidate hypotheses generated from a query formula and background knowledge, constraints to be satisfied by the candidate hypotheses;

a step of searching for and deleting redundant constraints not to affect an inference result from the enumerated constraints; and

a step of generating a combinatorial optimization problem from the plurality of candidate hypotheses and a set of enumerated constraints that remain after the deletion of redundant constraints.

(Supplementary Note 6)

A computer-readable recording medium that includes a program recorded thereon, the program including instructions that cause a computer to carry out:

a step of enumerating, for a plurality of candidate hypotheses generated from a query formula and background knowledge, constraints to be satisfied by the candidate hypotheses;

a step of searching for and deleting redundant constraints not to affect an inference result from the enumerated constraints; and

a step of generating a combinatorial optimization problem from the plurality of candidate hypotheses and a set of enumerated constraints that remain after the deletion of redundant constraints.

As the describe, the present invention has been described with reference to the embodiments, the present invention is not limited to the above embodiments. Various changes that can be understood by those skilled in the art can be made to the configuration and details of the present invention within the scope of the present invention.

### REFERENCE SIGNS LIST

1 constraint enumeration unit
2 redundant constraint deletion unit
3 candidate hypothesis conversion unit
4 candidate hypothesis generation unit
5 best hypothesis search unit
111 CPU
112 main memory
113 storage device
114 input interface
115 display controller
116 data reader/writer
117 communication interface
118 input apparatus
119 display apparatus
120 recording medium
121 bus
D1 the query formula
D2 background knowledge
D3 candidate hypothesis set
D4 best hypothesis

What is claimed is:

1. An information processing apparatus comprising:
a constraint enumeration unit that enumerates, for a plurality of candidate hypotheses generated from a query formula and background knowledge, constraints to be satisfied by the candidate hypotheses;
a redundant constraint deletion unit that searches for and deletes redundant constraints not to affect an inference result from the constraints enumerated by the constraint enumeration unit; and
a candidate hypothesis conversion unit that generates a combinatorial optimization problem from the plurality of candidate hypotheses and a set of constraints enumerated by the constraint enumeration unit that remain after the deletion of redundant constraints by the redundant constraint deletion unit.

2. The information processing apparatus according to claim 1,
wherein the plurality of candidate hypotheses are represented in a form of a latent hypothesis graph represented as a directed graph with literals as nodes, and
the redundant constraint deletion unit searches for redundant constraints, based on a graph structure of the latent hypothesis graph.

3. The information processing apparatus according to claim 1, comprising:
a candidate hypothesis generation unit that generates a candidate hypothesis set which is a set of candidate hypotheses, from the query formula and the background knowledge,
wherein the constraint enumeration unit enumerates constraints for the respective candidate hypotheses included in the candidate hypothesis set generated by the candidate hypothesis generation unit.

4. The information processing apparatus according to claim 1, comprising:
a best hypothesis search unit that searches for a best hypothesis using an external solver, based on the optimization problem generated by the candidate hypothesis conversion unit.

5. An information processing method comprising:
enumerating, for a plurality of candidate hypotheses generated from a query formula and background knowledge, constraints to be satisfied by the candidate hypotheses;
searching for and deleting redundant constraints not to affect an inference result from the enumerated constraints; and
generating a combinatorial optimization problem from the plurality of candidate hypotheses and a set of enumerated constraints that remain after the deletion of redundant constraints.

6. A non-transitory computer-readable recording medium that includes a program recorded thereon, the program including instructions that cause a computer to carry out:
enumerating, for a plurality of candidate hypotheses generated from a query formula and background knowledge, constraints to be satisfied by the candidate hypotheses;
searching for and deleting redundant constraints not to affect an inference result from the enumerated constraints; and
generating a combinatorial optimization problem from the plurality of candidate hypotheses and a set of enumerated constraints that remain after the deletion of redundant constraints.

7. The information processing method according to claim 5,
wherein the plurality of candidate hypotheses are represented in a form of a latent hypothesis graph represented as a directed graph with literals as nodes, and
when searching for and deleting redundant constraints, redundant constraints are searched, based on a graph structure of the latent hypothesis graph.

8. The information processing method according to claim 5, comprising:
generating a candidate hypothesis set which is a set of candidate hypotheses, from the query formula and the background knowledge,
wherein when enumerating constraints, constraints for the respective candidate hypotheses included in the candidate hypothesis set generated are enumerated.

9. The information processing method according to claim 5, comprising:
searching for a best hypothesis using an external solver, based on the optimization problem generated.

10. The non-transitory computer-readable recording medium according to claim 6,
wherein the plurality of candidate hypotheses are represented in a form of a latent hypothesis graph represented as a directed graph with literals as nodes, and
when searching for and deleting redundant constraints, redundant constraints are searched, based on a graph structure of the latent hypothesis graph.

11. The non-transitory computer-readable recording medium according to claim 6, comprising:
generating a candidate hypothesis set which is a set of candidate hypotheses, from the query formula and the background knowledge,
wherein when enumerating constraints, constraints for the respective candidate hypotheses included in the candidate hypothesis set generated are enumerated.

12. The non-transitory computer-readable recording medium according to claim 6, comprising:
searching for a best hypothesis using an external solver, based on the optimization problem generated.
